(19) United States
(12) Patent Application Publication
(10) Pub. No.: US 2020/0115046 A1
(43) Pub. Date: Apr. 16, 2020

(54) SYSTEM AND METHOD FOR AUTOMATED LANDING OF A PARACHUTE-SUSPENDED BODY

(71) Applicant: URBAN AERONAUTICS, LTD., Yavne (IL)

(72) Inventor: Raphael Yoeli, Tel-Aviv (IL)

(21) Appl. No.: 16/316,518

(22) PCT Filed: Jul. 26, 2017
(86) PCT No.: PCT/IL2017/050836

§ 371 Date: Jan. 9, 2019

Related U.S. Application Data
(60) Provisional application No. 62/367,896, filed on Jul. 28, 2016.

(51) Int. Cl. B64C 31/036; B64C 39/02

(52) U.S. Cl. CPC B64C 31/036; B64C 39/024; B64C 2201/185; B64C 2201/141; B64C 2201/027

(57) ABSTRACT

A system for automated landing of an airborne body suspended on a parawing includes a case with a powered pulley driven by a controlled motor to extend and extract cables attached to the parawing. The cables are extended at the beginning of the landing approach to locate the parawing away from the airborne body, while maintaining the tension of the parawing straps to ensure that the parawing maintains aerodynamic behavior. When the airborne body lands and is secured to the landing pad, the cables are unwound until the parawing approaches the airborne body at which stage it is deflated and collected.

### BACKGROUND OF THE INVENTION

Landing of a body (herein LB), that is suspended by a ram-air inflatable parachute (sometimes called ‘parafoil’ or as in this text ‘parawing’), whether that body is a powered body (PB) or a non-powered body, collectively denoted parachute suspended body, or PSB, on a very small landing pad, such on a ship or boat, which is, additionally or alternatively, within a confined area surrounded by obstacles, and specifically in gusty wind conditions, presents several problems such as how to prevent the parawing from falling out of the landing pad (and in case of landing on a ship-falling into the water), how to prevent the parawing from getting caught by obstacles, such as trees, and the like. A LB may refer to any physical body that is airborne suspended from a parachute, and in this application suspended from a parawing, and is aimed to land. This may comprise parachuted packages (supplies thrown from a cargo airplane and the like) and other parachuted bodies that may be powered as explained in details below. In this application, the LB may be manned, where at least some the landing process is controlled manually by a person riding the LB, or the LB may be unmanned, where the landing process is self-controlled on board of the LB and or is controlled from remote. A PB may comprise forward thrust means, such as in the case of a powered parawing, sometimes also called ‘paramotor’ and some cases it may additionally comprise vertical thrust means. The exemplary embodiments described below refer to various types of powered bodies suspended by parawing, which will be denoted herein after powered fuselage (PF). It would apparent to those skilled in the art that methods and systems described with regard to these powered configurations may be used in other configurations, with the apparent required modifications.

Landing of a PF on small landing pad requires transition phase of flight, from flight where the weight of the PF is fully supported by the parawing, to flight where the weight of the PF is supported by its powered lift producer, such as lift fans, or the like. Obviously, the transition exerts changes of the pulling forces acting on the parawing strings, from forces adapted to support the PF weight to forces equal substantially to zero, which in turn may cause the parawing to collapse and terminate its aerodynamic behavior, turning it into a large sheet pulled by its strings behind the PF.

With present day equipment (e.g. ‘powered parawings’ or ‘paramotors’), such a landing would encounter two major challenges which could render it impossible. First, the Parawing, being very large relative to the confined landing area sought, could get entangled in obstacles. Second, any wind blowing into the landing area, especially if it becomes turbulent as a result of it blowing over obstacles surrounding or in the vicinity of the landing area (for example the superstructure of a ship or boat behind which the landing is attempted) will pose significant danger to the PF and could even cause the Parawing that supports it to stall or suffer a partial or full leading edge collapse or both, which would cause a catastrophic accident.

There is a need for system and method for managing and controlling the landing of a PSB on a very small landing pad while ensuring that the parawing is controlled and maintained at all times and is secured from being tangled, stalled or otherwise get out of control.

### SUMMARY OF THE INVENTION

A system for automated landing of an airborne body suspended on a parawing is disclosed, the system comprising a case, adapted to be attached to the airborne body. The case comprising at least one powered pulley adapted, each, to wind and unwind a cable, a controllable motor for driving each of the at least one powered pulley adapted to rotate the pulley for winding/unwinding the cable, a plurality of sensors adapted to provide indication of at least one of linear speed of winding/unwinding the cable, tension of the cable and the length of the cable extending out of the system and a control unit adapted to receive the indications from the plurality of sensors and to control at least the speed and direction of rotation of the at least one pulley and the duration of operation of the pulley.

In accordance with embodiments of the invention the controllable motor is adapted to provide tension no less than a predefined tension threshold and to wind/unwind the cable in a cable linear speed no less than a predefined threshold speed.

In accordance with embodiments of the invention the system further comprising angularity sensors adapted to provide to the control unit indications of relative angle of the cable with respect to a reference plane on the airborne body.

In some embodiments of the invention the airborne body is unmanned.

In some embodiments of the invention the airborne body is a vehicle equipped with forward thrust means. In some additional embodiments, the airborne vehicle is further equipped with vertical lift means.

In some embodiments of the invention the airborne vehicle is autonomous.

In some embodiments, the control unit is adapted to receive indications of the relative location of the autonomous airborne vehicle along its landing approach and to switch between modes of control of the system in response. In some additional embodiments, the control unit is further adapted to receive indications of one or more from global geo location indication of the autonomous airborne vehicle and wind conditions near the autonomous airborne vehicle.

In some embodiments, the speed of unwinding/winding of the cable is determined to exert a required tension to the cable. In some additional embodiments, the speed of unwinding/winding of the cable is also determined so to ensure that the airspeed on the parawing is no less than a predefined parawing stall speed.

A method for automated landing of an airborne body suspended on a parawing on a landing pad is disclosed, the method comprising, when the autonomous airborne vehicle passes the beginning point of the landing approach, beginning reduction of the airspeed of the airborne body, and beginning extending the cable attached to the parawing. After this step stopping extension of the length of the cable when its length reached a predefined secure distance from the airborne body and, at the end of the landing, securing the autonomous airborne body to the landing pad and extending the cable attached to the parawing until the parawing reaches the landing pad.

According to some embodiments the airborne body is an airborne vehicle equipped with forward thrust means and vertical lift means and the method further comprising, following the beginning of reduction of the airspeed of the airborne vehicle, increasing gradually vertical lift power of the autonomous airborne vehicle while maintaining extending the cable; when vertical lift power of the airborne vehicle passes approaches the magnitude of the weight of the airborne vehicle stopping extending of the cable, during the landing approach maintaining the cable tension above a predefined cable tension threshold and maintaining the parawing airspeed above a parawing airspeed threshold, and when the vertical lift power provide by the parawing reaches substantially zero beginning pulling of the cable towards the airborne vehicle, while ensuring that the cable tension is at least more than predefined cable tension threshold.

In some embodiments, the airborne vehicle comprising a control unit adapted to receive indication of the speed of winding/unwinding the cable, to receive indication of the tension of the cable extension, to receive indication of the length of the cable extending out; and to control the speed of winding/unwinding the cable.

In some embodiments, the method further comprising maintaining a defined tension of the cables during the landing approach.

In some embodiments, the method further comprising, after the step of securing the autonomous airborne body to the landing pad, collecting and stowing the parawing with the airborne vehicle.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A schematically depicts powered fuselage suspended by a parawing (PSB), according to embodiments of the present invention;

FIG. 1B is a schematic illustration of elements comprised in a parawing straps tension and length (STL) control system, according to embodiments of the present invention;

FIG. 2 schematically shows three consecutive landing stages, of a powered fuselage (PF) of a first configuration attached to a parawing, according to embodiments of the present invention;

FIG. 3 schematically shows four consecutive landing stages, of a PF with a parawing of a second configuration, according to embodiments of the present invention; and

FIG. 4 is a flow diagram depicting stages of landing of a PF with a parawing of a second configuration, according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The description of embodiments of the present invention relates, in general, to the variety of physical bodies that cruise to landing on a parachute of the parawing type, whether the body is unpowered or powered, whether the powered body provides only forward thrust, only vertical lift, or both; whether the body is manned or unmanned. The examples given below relate, mostly to two different configurations, namely parachuting body with only forward thrust and parachuting body with forward thrust and vertical lift. It would apparent to those skilled in the art that methods and systems described with regard to these two configurations may be used in other configurations, with the apparent required modifications.

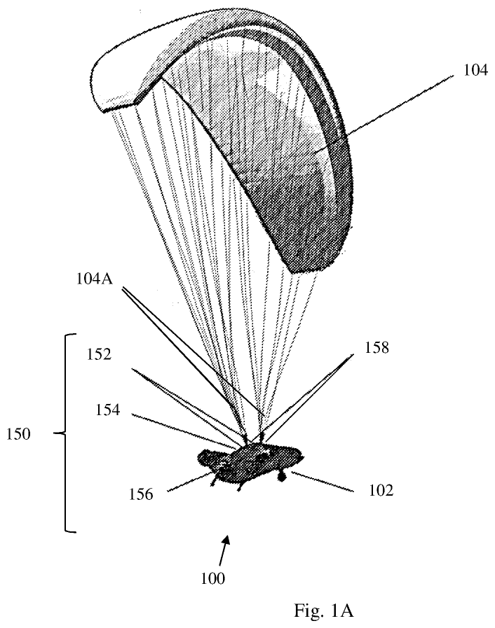

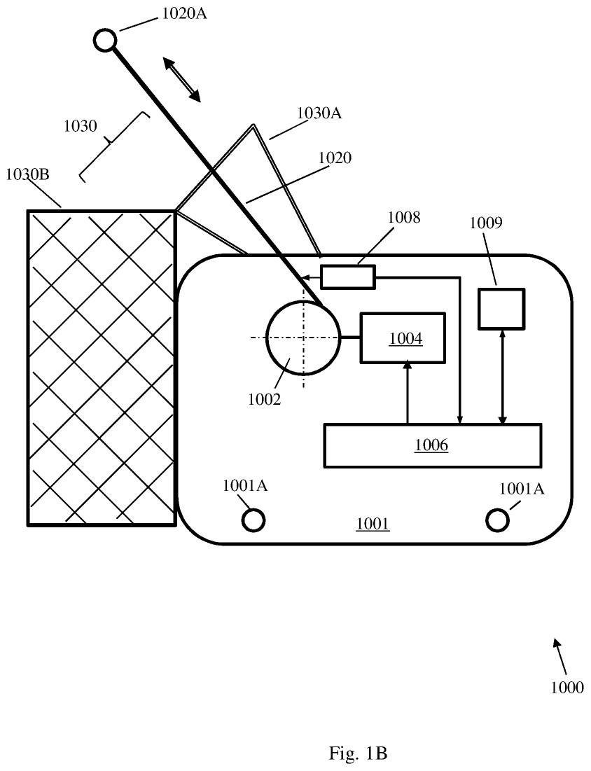

Reference is made to FIG. 1A, which schematically depicts a parachute suspended body (PSB) 100 according to embodiments of the present invention. PSB 100 may comprise PF 102 (also denoted autonomous airborne vehicle), parawing 104 having parawing straps 104A adapted to enable attaching PF 102 to parawing 104, a parawing straps tension and length (STL) control system 150 comprising a case, which is securely attachable to the PF fuselage. STL control system 150 is further adapted to be connected straps of the parawing, as is described in details herein below. STL control system 150 comprise of a plurality of powered and controlled pulleys 152, adapted to wind/unwind straps connectable to the parawing in a controlled speed and controlled length. STL control system 150 further comprises variable speed motors unit 154 adapted to drive controlled pulleys 152, and a control unit 156, that is adapted to receive plurality of inputs and to control the direction and speed of winding/unwinding straps onto/from pulleys 152. STL control system 150 further comprises sensors 158, adapted to provide signals to control unit 156 indicative of at least one of the tension in each of the cables/straps attaching the parawing to PF 102 and the angular orientation of the cables/straps in two axes of each cable, relative to a reference spatial 3D axes system on PF 102, for example axes that are parallel to the longitudinal axis of PF 102, to an axis perpendicular to the longitudinal axis that is parallel to the PSB 100 lateral axis and a third axis perpendicular the previous two.

The plurality of variable speed motors in unit 154 are adapted to propel pulleys 152 in both directions, wind and unwind, to affect winding or unwinding of the parawing's straps, as may be required.

STL control system 150 further comprise revolution counters (not shown) for providing indication of the number, direction and speed of rotation of pulleys 152 and/or motors 154, to enable STL control system 150 to measure and/or estimate the length of cable that has been released from each pulley and/or rolled back onto the pulley.

In addition to the main wires and straps 104A attaching parawing 104 to the PF 102, parawing 104 may optionally have auxiliary wires (not shown) for controlling the trailing edge of the parawing 104 canopy so as to operate them as “flaps”, as commonly done in paragliders by pulling down/releasing to rise up sections of the trailing edge for controlling turns and air braking. These wires and their controls are not shown, however they may be present and functional to control the maneuvers described herein to provide directional control and/or desired pitch variations of parawing 104 relative to the PF 102.

Using the system as described in FIG. 1A, an aircraft such as PF 102 may be able to make safe landings into a confined landing area following the procedure as described below, which are examples of many possible methods of operating the system.

There are mainly two different cases, according to two different configurations of the PF, to consider. According to the first configuration the PF provides thrust that is substantially directed forward with respect to the direction of flight, but relies on the parawing exclusively for lift. This case is represented by the well-known powered parawing, sometimes also called ‘paramotor’. In the second configuration, a PF has the capability for vertical takeoff and landing (VTOL) independent of an auxiliary parawing. This could be any one from a large number of vehicles known today or planned for the future, such as Paul Moller's Skycar of Moller Int., or the AirMule of Tactical Robotics Ltd., and Cormorant VTOL aircraft of Tactical Robotics Ltd., that have lift rotors, shrouded or open, contained or mounted in such a way, sideways or otherwise, that they do not interfere with the straps and wires that attach the airborne vehicle to the parawing. It should be noted that the use of a parawing or similar parachute on such vehicles may be beneficial to for a variety reasons, including but not limited to, reduction of fuel consumption in order to extend flight endurance, or reduction of noise generated by the PF, or to be deployed in flight following an emergency or catastrophic failure of any of the systems required for the PF to continue flying under its own power.

It will be noted that according to some embodiments, each of the various PF described herein and/or its STL control system 150 may receive indications of the location of the PF with respect to a global reference geo location system (such as a GPS) and/or with respect to the landing pad it is about to land on. According to yet additional embodiments the PF may receive indications of wind conditions in the vicinity of its flight close to the intended landing pad.

Reference is made to FIG. 1B, which is a schematic illustration of elements comprised in a parawing straps tension and length (STL) control system 1000, according to embodiments of the present invention. STL 1000 may comprise STL case or chassis 1001 with means 1001A adapted to attach STL control system 1000 to a body suspended by and cruising to its landing location on a parawing. STL 1000 further comprises one or more pulleys 1002 adapted to wind/unwind one or more cables 1020, which are adapted to be connected to suspension straps of a parawing via connection means 1020A. Pulleys 1002 may wind/unwind cable 1020 of lengths as dictated by the specific need and use, in some embodiments length of 1000 m or more. Pullies 1002 may be powered (i.e. motorized) by motor means 1004. Motor means 1004 may be one or more motors, motor-gears and the like. The motor may be electrical or another, as my suit the specific need and use. The speed and direction of rotation of motor means 1004 are controllable by control unit 1006.

STL control system 1000 further comprises sensors unit 1008, adapted to reflect the status of cables 1020, comprising reflecting one or more of the following features and status of cable 1020: cable tension, cable direction of movement, cable extension/retraction length, cable angularity with respect to reference plane on STL control system 1000 or on the respective FB. Sensors unit 1008 is adapted to reflect cables' 1020 status to control unit 1006.

Controller 1006 which is comprised in STL control system 1000 is adapted to provide control control signals to motor means 1004 in order to determine and control their direction and amount of rotation, and to receive cables' status signals from sensors unit 1008. In some embodiments STL control system 1000 may further comprise communication and location unit 1009, adapted to enable communication of STL control system 1000 with remote unit, to transmit operational status information to the remote unit and optionally to receive information from a remote unit. Communication and location unit 1009 may further comprise geo or relative location means, adapted to provide location information in a universal location system, such a GPS system, or relative location adapted to provide location relative to a selected position, for example location relative to an intended landing pad.

In some embodiments STL control system 1000 may further comprise parawing collecting and folding assembly 1030 comprising cable and parawing funnel 1030A and optionally parawing stowing compartment 1030B. Parawing collecting and folding assembly 1030 is adapted to collect the parawing at the final stage of landing when cables 1020 are wounded into STL control system 1000 and the parawing straps have been substantially fully wounded following cables 1020, and to enable accommodating the canopy sheet of the parawing in stowing compartment 1030B, thereby preventing it from being pulled and dragged behind the landed PF, in case of a landing on a moving landing pad, or simply have the parawing sheet been nicely gathered and kept in other cases.

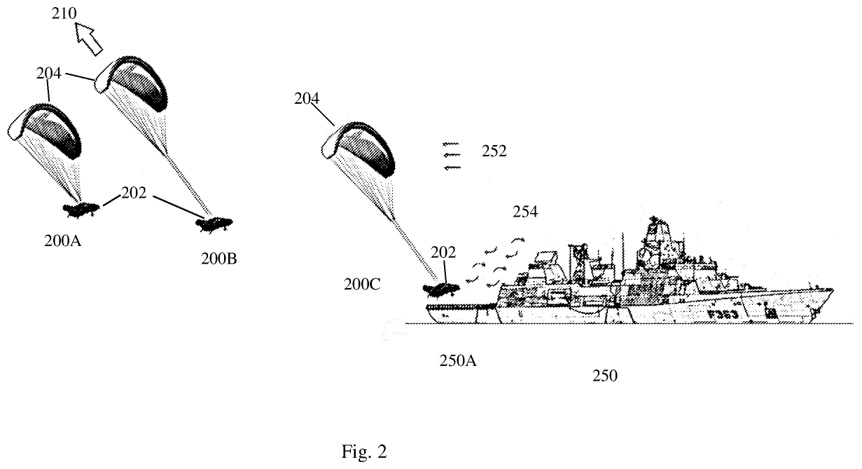

Reference is made no to FIG. 2, which schematically shows three consecutive landing stages, 200A, 200B and 200C, respectively, of landing of PF 202 of the first configuration attached to parawing 204, according to embodiments of the present invention. It will be noted that PF 202 is equipped with a STL control system, such as STL control system 150 of FIG. 1A or STL control system 1000 of FIG. 1B, which are not shown here in order to not obscure the drawing. Arrows 252 denote a region of smooth, or laminar blow of air. Zone 254 denotes a region with turbulent air.

In stage 200A PF 202 is shown in forward cruising, where PF 202 provides forward thrust and parawing 204 provides lift.

In stage 200B, as PF 202 approaches a landing zone, particularly but not limited to, a confined and/or turbulent landing zone such as landing pad 250A on ship 250, the STL control system may be instructed to extend the straps of parawing 204 outward, as indicated by arrow 210. Extension of the straps may be carried out using the pulleys and motors of the STL control system, as described with respect to FIGS. 1A and 1B. Extension of the straps is required to distance parawing 204 from PF 202 just enough to clear any obstruction and/or turbulence in the area. The amount of extension for clearing the parwing from obstruction and/or turbulent zone may be pre-calculated for given PF 202, parawing 204 and ship 250 and may be updated according to current local wind, direction and speed of cruise, etc. Similarly, the distance of PF 202 from landing zone 250A at which stage 200B commences, may be pre-calculated as described above. Wires used for control may be extended as well, either with separate pulleys and motors or with a fixed length to a predetermined extension length.

PF 202 may then perform a normal landing as shown in stage 200C of FIG. 2. Following the landing and if there is a means to secure F 202 to the ground or deck, parawing 204 may be pulled back prior to deflation. Alternatively, after landing parawing 204 may be deflated as normally carried out on a ‘Paramotor’ albeit with longer straps attaching the Parawing to the PF.

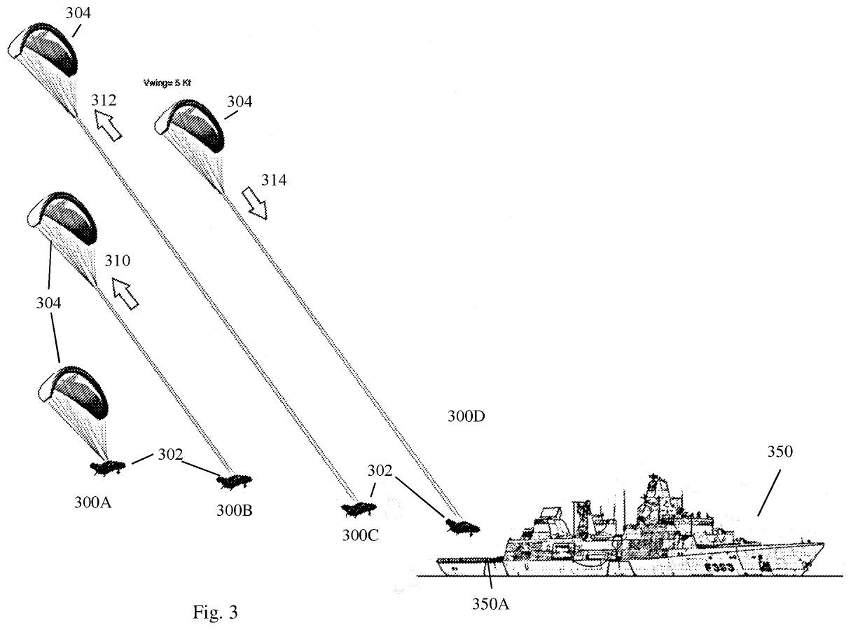

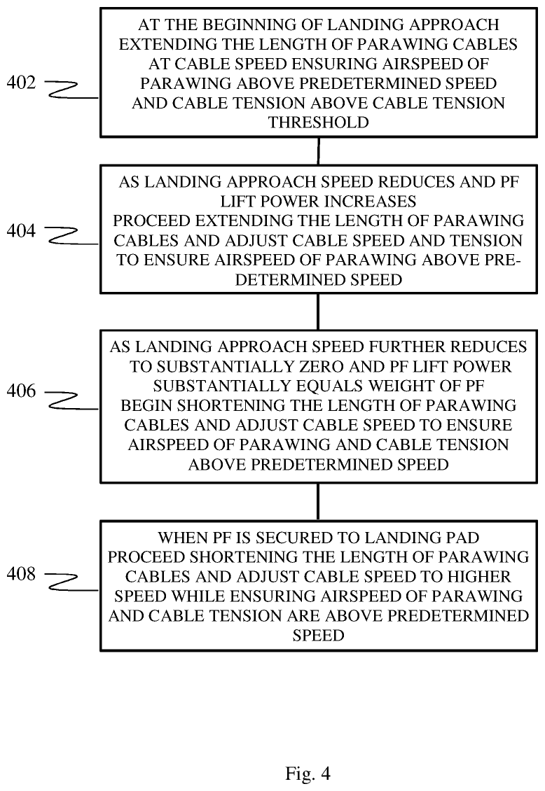

Reference is made now to FIG. 3, which schematically shows four consecutive landing stages, 300A, 300B, 300C and 300D, respectively of PF 302 with parawing 304 of the second configuration, according to embodiments of the present invention. It will be noted that PF 302 is equipped with a STL control system, such as STL control system 150 of FIG. 1A or STL control system 1000 of FIG. 1B, which is not shown here in order to not obscure the drawing. Reference is also made here to FIG. 4, which is a flow diagram depicting stages of landing of a PF with a parawing of a second configuration, according to embodiments of the present invention.

In stage 300A PF 302 is cruising while providing the forward thrust and parawing 304 provides 100% of the required lift. Representative figures that may exist at this stage are 35 Kt of PF 302 during cruise, 35 Kt of parwing 304 and parawing 304 cables load 1500 Kg, which is the weight of PF 302 with the added tension exerted by the aerodynamic drag of parawing 304, in a typical example.

In stage 300B, corresponding to step 402 of FIG. 4, as PF 302 starts the approach to landing area 350A on ship 350, the STL control system may command the motors to operate the pulleys to begin extending cables attached to the straps of parawing 304, causing parawing 304 to rise above and behind PF 302, as shown by arrow 310. The purpose of the extension is three-fold. First, to clear parawing 304 from the obstacles and turbulence that might be present at and around landing area 350A. Second, to clear parawing 304 from the vicinity of PF 302 as its lift rotors begin to create lift, thereby eliminating the danger of parawing 304 being sucked into the lift rotors or otherwise dysfunction.

The rate of extending of the cables should take in account the speed V_{PWST} at which parawing 304 stalls and should ensure that at all times before parawing 304 collapses at the end of the landing, its air speed will be higher than V_{PWST}. Further, to facilitate, the reduction of the lift provided by parawing 304 should be in concert with the engagement and gradual increase of lift from the lift rotors on PF 302, which throughout the cruise stage of flight have been either disengaged completely or at a blade pitch angle that essentially did not produce any lift. Reduction of lift on parawing 304 can be accomplished using aerodynamic means such as deliberate partial folding of the parawing, activation of various spoilers or other means. The method of the present invention described herein below relies merely on a controlled release of the cables at an increasing rate to affect the net apparent incoming air velocity experienced by parawing 304. Other means, e.g. those mentioned above, may be used additionally, however they are not discussed in this specification. The resultant net apparent incoming air velocity will be, as a first approximation, the difference between the forward flight speed of PF 302 and the release speed of the cable (the speed measured along the cable) corrected for the angularity of the cable with regard to the Horizon. In addition, the estimated prevailing winds have to be factored in, all of which may be performed by the STL control system, considering also the information from tension and angularity sensors of the STL control system.

It should be noted that the angle of the cables connecting PF 302 to parawing 304 in FIG. 3 has not been taken into account in the exemplary numbers given below for the velocities of PF 302, cable release length and speed and parawing 304 speed. These numbers are presented merely for reference and to better explain the present invention. These velocities could differ depending on a variety of conditions, such as actual headwind, velocity of the landing pad (in case it is located on a ship or other moving platform such as motor vehicle), variations in wind speed at different heights in the range dictated by the released cables of parawing 304, etc.

In the example shown in FIG. 3 it is furthermore estimated, based on experience with similar parawings, that parawing airspeed of 5 Kt is sufficient to keep the parawing inflated, supporting its own weight and substantially self-supporting form, with some excess lift to keep the cables in tension. This required excess lift is set arbitrarily as 50 Kg in the example shown but it should be noted that the system may be calibrated for any desired cable tension and cable self-weight. For example, it may be desirable to reduce this load depending, among others, on the ability of PF 302 to handle the landing with the additional difficulty of an external load exerted on its back. At stage 300B, assuming that the forward speed of PF 302 is 35 Kt the rate of release of the cable will be dictated by:

V_{CR}=V_{PF}−V_{PW}=35−10=25 Kt≅13 m/sec

Where:

V_{CR}—speed of cable release

V_{PF}—speed of the PF

V_{PW}—required speed of the parawing

In stage 300C, corresponding to step 404 of FIG. 4, PF 302 slows down but with its full weight already supported by its lift rotors, minus the exemplary 50 Kg tension in the cables connected to parawing 304, ignoring for now the correction due to cable's angularity. Because the tension in the cable has reduced from the full weight, e.g. 1,500 Kg, it had during cruise to just about 50 Kg, the interference of parawing 304 with the landing of PF 302 may be minor or negligible. For example, the speed of release the cable at this stage, as denoted by arrow 312, may be the algebraic difference between the forward speed of PF 302, e.g. 20 Kt, to the minimal required speed of parawing 304. That is 20−5=15 Kt (=approx. 8 m/sec).

In stage 300D, corresponding to step 406 of FIG. 4 PF 302 is shown after it has come to a hover above landing pad 350A. at this stage, in order to keep parawing 304 from stalling in case there is no strong enough prevailing wind, the pulleys of the STL control system may start rewinding the cables, as dented by arrow 314, at a rate sufficient to keep parawing 304 above Vstall/above deflation speed, e.g. 3 m/sec, which exerts approximately 5 Kt of airspeed on parawing 304, which considered sufficient to keep parawing 304 aloft without collapsing. According to one embodiment the direction and speed of rotation of the motors powering the pulleys of the STL control system may be controlled predominantly by one main consideration, that is keeping the tension in the cables at a predetermined positive value, e.g. 50 Kg as in the example discussed above.

After landing, as depicted in step 408 of FIG. 4, and once PF 302 is secured on board of ship 350, the rewind speed of the cables may be increased to collect parawing 304 at a rate faster than that used during final landing stage.

It should be noted that the landing stage described above considered, for simplicity only, a ‘zero prevailing wind’ case. Assuming that PF 302 typically lands into the wind (“nose wind”), the prevailing winds do not change the basic method described herein. However, additional prevailing wind will require faster cable release rates. Also, for a fixed duration landing procedure a longer total length of cable will be required. It should also be noted that assuming a landing sequence according to FIG. 3 with a total duration of one minute (60 seconds), at an average cable release rate of 35/2 Kts=8 m/sec the total length of cable deployed adds up to approximately 500 meters. If the prevailing wind is, for example, not zero as in the previous example, but is also 35/2=17 Kt, then the cable length doubles to approximately 1,000 meters.

While certain features of the invention have been illustrated and described herein, many modifications, substitutions, changes, and equivalents, each comprising a vehicle that is equipped with a mechanism comprising parawing collecting and folding funnel, that is adapted to deflate and collapse the parawing as it draws close to the vehicle, will now occur to those of ordinary skill in the art. It is, therefore, to be understood that the appended claims are intended to cover all such modifications and changes as fall within the true spirit of the invention.

What is claimed is:

1. A system for automated landing an airborne body suspended on a parawing, the system comprising:
a case, adapted to be attached to the airborne body, the case comprising:
at least one powered pulley adapted, each, to wind and unwind a cable;
a controllable motor for driving each of the at least one powered pulley, adapted to rotate the pulley for winding/unwinding the cable;
a plurality of sensors adapted to provide indication of at least one of linear speed of winding/unwinding the cable, tension of the cable and the length of the cable extending out of the system; and
a control unit adapted to receive the indications from the plurality of sensors and to control at least the speed and direction of rotation of the at least one pulley and the duration of operation of the pulley;
wherein, the controllable motor is adapted to provide tension no less than a predefined tension threshold and to wind/unwind the cable in a cable linear speed no less than a predefined threshold speed.

2. The system of claim 1, further comprising:
angularity sensors adapted to provide to the control unit indications of relative angle of the cable with respect to a reference plane on the airborne body.

3. The system of claim 1 wherein the airborne body is unmanned.

4. The system of claim 1 wherein the airborne body is a vehicle equipped with forward thrust means.

5. The system of claim 4 wherein the airborne vehicle is further equipped with vertical lift means.

6. The system of claim 5, wherein the airborne vehicle is an autonomous vehicle.

7. The system of claim 1, wherein the control unit is adapted to receive indications of the relative location of the autonomous airborne vehicle along its landing approach and to switch between modes of control of the system in response.

8. The system of claim 7, wherein the control unit is further adapted to receive indications of one or more from global geo location indication of the autonomous airborne vehicle and wind conditions near the autonomous airborne vehicle.

9. The system of claim 1, wherein the speed of unwinding/winding of the cable is determined to exert a required tension to the cable.

10. The system of claim 9, wherein the speed of unwinding/winding of the cable is further determined so to ensure that the airspeed on the parawing is no less than a predefined parawing stall speed.

11. A method for automated landing of an airborne body suspended on a parawing on a landing pad, the method comprising:
when the autonomous airborne vehicle passes the beginning point of the landing approach:
beginning reduction of the airspeed of the airborne body, and concurrently
beginning extending the cable attached to the parawing;
stopping extension of the length of the cable when its length reached a predefined secure distance from the airborne body; and
at the end of the landing securing the autonomous airborne body to the landing pad and extending the cable attached to the parawing until the parawing reaches the landing pad.

12. The method of claim 11 wherein the airborne body is an airborne vehicle equipped with forward thrust means and vertical lift means, the method further comprising, following the beginning of reduction of the airspeed of the airborne vehicle:
increasing gradually vertical lift power of the autonomous airborne vehicle while maintaining extending the cable;
when vertical lift power of the airborne vehicle passes approaches the magnitude of the weight of the airborne vehicle stopping extending of the cable;
during the landing approach maintaining the cable tension above a predefined cable tension threshold and maintaining the parawing airspeed above a parawing airspeed threshold; and
when the vertical lift power provide by the parawing reaches substantially zero beginning pulling of the cable towards the airborne vehicle, while ensuring that the cable tension is at least more than predefined cable tension threshold.

13. The method of claim 12 wherein the airborne vehicle is unmanned.

14. The method of claim 13 wherein the airborne vehicle is autonomous.

15. The method of claim 14 wherein the airborne vehicle comprising a control unit adapted to:
receive indication of the speed of winding/unwinding the cable;
receive indication of the tension of the cable extension;
receive indication of the length of the cable extending out; and
to control the speed of winding/unwinding the cable.

16. The method of claim 15 further comprising:
maintaining a defined tension of the cables during the landing approach.

17. The method of claim 16 wherein the maintained tension is determined to ensure that the parawing maintains its aerodynamic form.

18. The method of claim 17 further comprising, after the step of securing the autonomous airborne body to the landing pad:
collecting and stowing the parawing with the airborne vehicle.
